(19) United States
(12) Patent Application Publication
(10) Pub. No.: US 2011/0083816 A1
(43) Pub. Date: Apr. 14, 2011

(54) Safety blind assembly

(76) Inventor: Kuei-Ting Chen, Dongshan Hsiang (TW)

(21) Appl. No.: 12/587,528

(22) Filed: Oct. 8, 2009

(51) Int. Cl. E06B 9/326

(52) U.S. Cl. 160/168.1 R

(57) ABSTRACT

A safety blind assembly has a rail, a shade, medium slats, a bottom slat, cords and a safety device. The shade is attached to a bottom edge of the rail. The medium slats and the bottom slat are separately mounted on the shade. The safety device has releasable rings and detachable connectors. The releasable rings are mounted on the medium slats and the detachable connectors are mounted on the bottom slat. The cords are mounted in the rail, pass through the releasable rings and are connected to the detachable connectors. When someone is wrapped with the cord and the cord is pulled outward from the shade, and the cord can be released from the releasable ring to loosen the cord to provide the first safety measure. If a pulling force of the cord exceeds a predetermined detach force, the detachable connectors detach to provide the second safety measure to avoid injury.

### BACKGROUND OF THE INVENTION

1. Field of the Invention

The present invention relates to a blind, and more particularly to a safety blind assembly having two safety measures to prevent strangulation or entanglement.

2. Description of Related Art

For shielding sunshine or external light and privacy, windows are usually provided with coverings, such as a blind. However, cords of the blind may be dangerous to young children and pets, especially threat of injury by strangulation or entanglement, so a safety blind is provided.

With reference to FIG. 6, a conventional safety blind has a rail (31), a shade (32), slats (33), rings (34), detachable connectors (35) and cords (36). The rail (31) is mounted securely on a wall or a ceiling and has a bottom edge. The shade (32) is attached to the bottom edge of the rail (31) and may be concertinaed. The slats (33) are separately and parallelly mounted on the shade (32). Each detachable connector (35) has a connector mount (351) and a connector insert (352). The connector mount (351) is attached to a bottom-most slat (33), and the connector insert (352) is inserted into the connector mount (351) and can selectively detach from the connector mount (351) when a pulling force overcomes a predetermined detaching force. Each cord (36) is mounted in the rail (31), through the corresponding rings (34) and fastened to the connector insert (352).

When children or pets are wrapped with cords (36) accidentally, pulling or dragging forces will cause the connector inserts (352) to detach from the connector mounts (351) so the cords (36) are loosened to prevent children or pets from strangulation or entanglement.

However, with reference to FIGS. 7 and 8, the connector insert (352) and the connector mount (351) of the detachable connector (35) have a predetermined connecting force that may be relatively hard to a baby to overcome. When a baby is wrapped with a section of the cord (36) that is fixed by adjacent rings (34), the section of the cord (36) may be an independent strangulation or entanglement threat unpreventable by the connector insert (352) not detaching from the connector mount (351).

Therefore, the present invention provides a safety blind assembly to overcome the aforementioned problems.

### SUMMARY OF THE INVENTION

An objective of the invention is to provide a safety blind assembly having two safety measures to prevent strangulation or entanglement.

The safety blind assembly in accordance with the present invention has a rail, a shade, medium slats, a bottom slat, cords and a safety device.

The shade is attached to a bottom edge of the rail. The medium slats and the bottom slat are separately mounted on the shade. The safety device has releasable rings and detachable connectors. The releasable rings are mounted on the medium slats and the detachable connectors are mounted on the bottom slat. The cords are mounted in the rail, pass through the releasable rings and are connected to the detachable connectors. When someone is wrapped with the cord and the cord is pulled outward from the shade, and the cord can be released from the releasable ring to loosen the cord to provide the first safety measure. If a pulling force of the cord exceeds a predetermined detach force, the detachable connectors detach to provide the second safety measure to avoid injury.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a safety blind assembly in accordance with the present invention;

FIG. 2 is a perspective view of a releasable ring of the safety blind assembly in FIG. 1;

FIG. 3 is a perspective view of the releasable ring of the safety blind assembly in FIG. 2 after a cord is released;

FIG. 4 is a front view in partial section of a detachable connector of the safety blind assembly in FIG. 1;

FIG. 5 is a front view in partial section of the detachable connector of the safety blind assembly in FIG. 4 once detached;

FIG. 6 is a front view of a conventional safety blind;

FIG. 7 is a perspective view of a ring of the conventional safety blind in FIG. 6; and

FIG. 8 is a perspective view of the ring of the conventional safety blind in FIG. 7 illustrating a section of a cord presenting an independent strangulation or entanglement threat.

### DETAILED DESCRIPTION OF PREFERRED EMBODIMENT

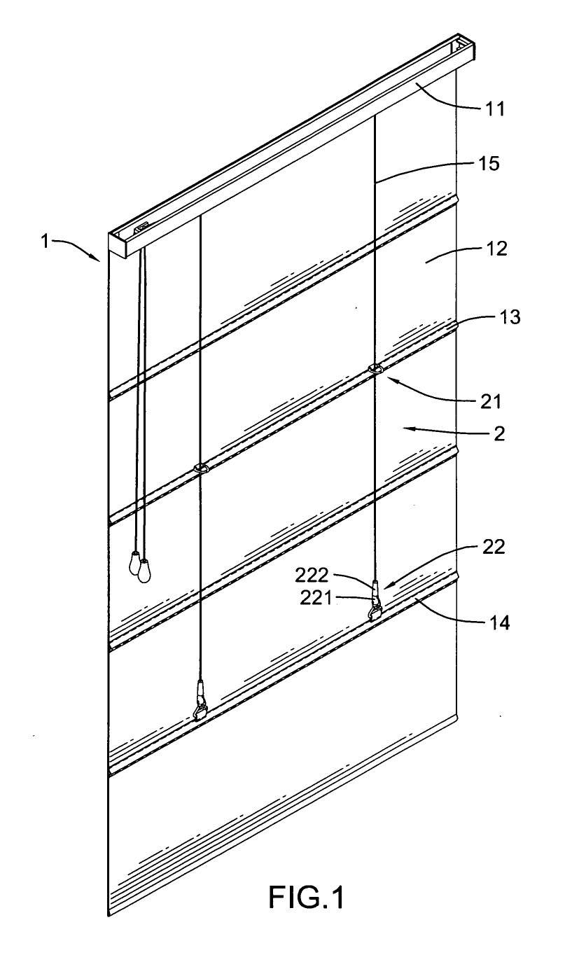

With reference to FIG. 1, a safety blind assembly comprises a blind (1) and a safety device (2).

The blind (1) has a rail (11), a shade (12), multiple medium slats (13), a bottom slat (14) and multiple cords (15). The rail (11) may be mounted securely near a window and has a bottom edge. The shade (12) is attached to the bottom edge of the rail (11) and may be concertinaed. The medium slats (13) are mounted parallelly and separately on the shade (12), and the bottom slat (14) is mounted under the medium slats (13) on the shade (12). Each cord (15) has a connecting end and a free end, and the connecting end is mounted in the rail (11).

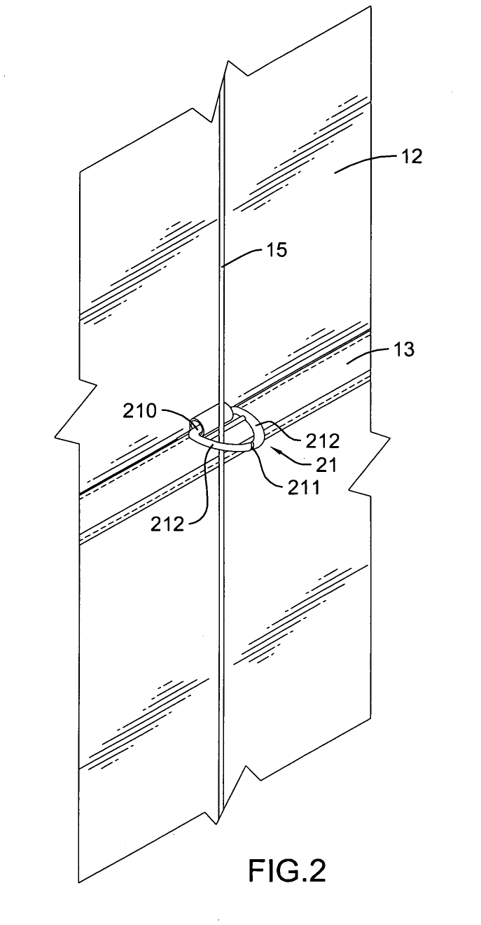

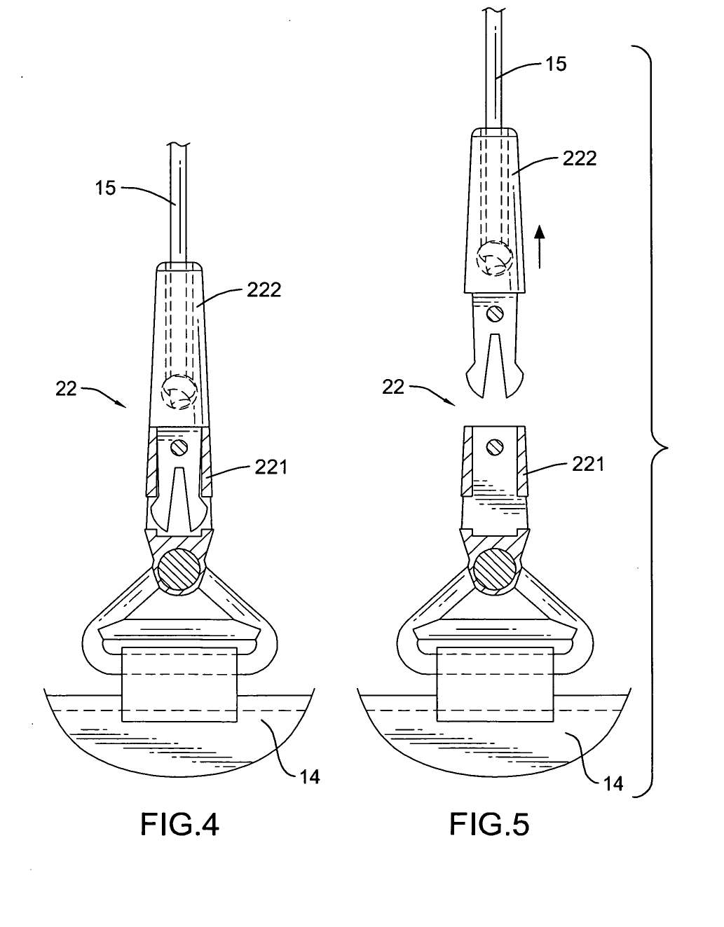

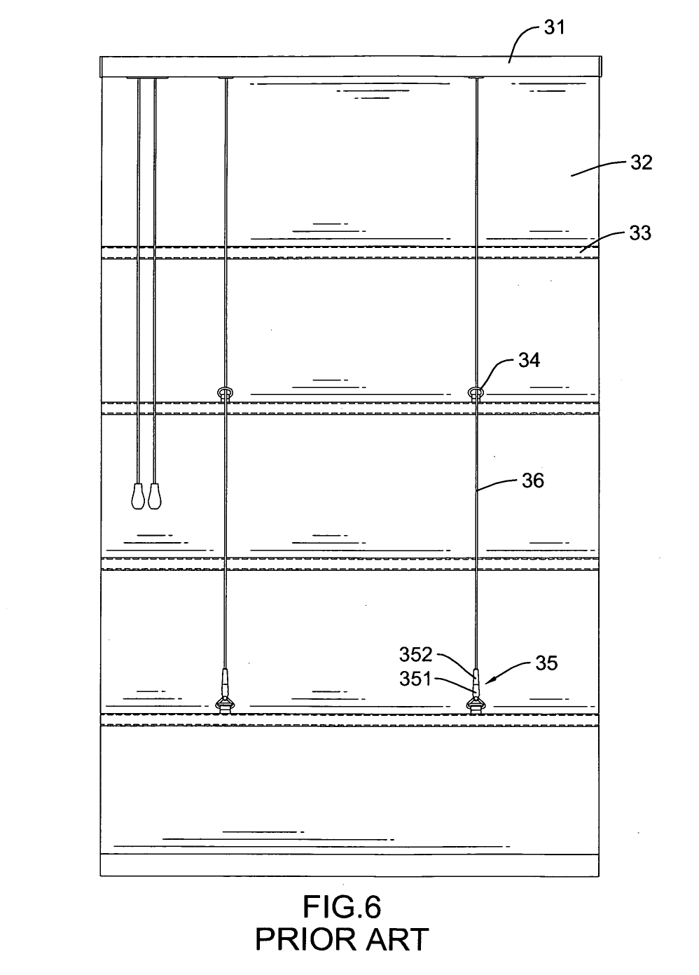

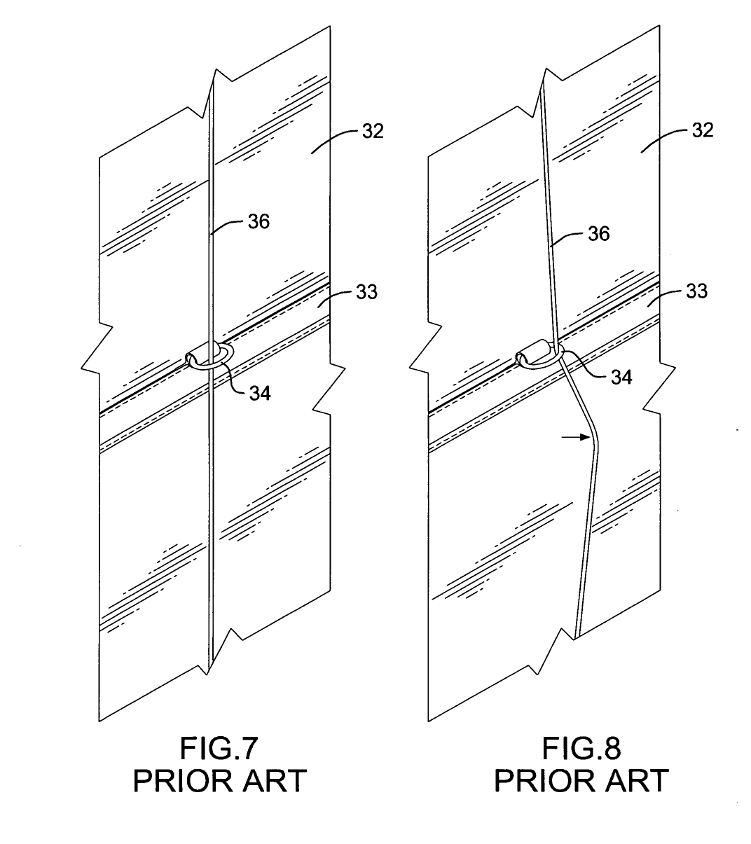

With reference to FIGS. 2 and 4, the safety device (2) has multiple releasable rings (21) and multiple detachable connectors (22). The releasable rings (21) are mounted on the medium slats (13), and each releasable ring (21) has a mounting section (210) and a gap (211) formed in the mounting section (210). The mounting section (210) may have two oblique restraining arms (212) and may be resilient. The oblique restraining arms may selectively abut one another at an apex of the releasable ring (21). The gap (211) is formed between the restraining arms (212) to allow the restraining arms (212) to open and may be formed at an apex between the arms (212). Each detachable connector (22) has a connector mount (221) and a connector insert (222), the connector mount (221) is mounted on the bottom slat (14), and the connector insert (222) is inserted into the connector mount (221) and is detachable from the connector mount (221). With reference to FIG. 1, the free end of each cord (15) is mounted downward through at least one releasable rings (21) and is fastened to a corresponding connector insert (222).

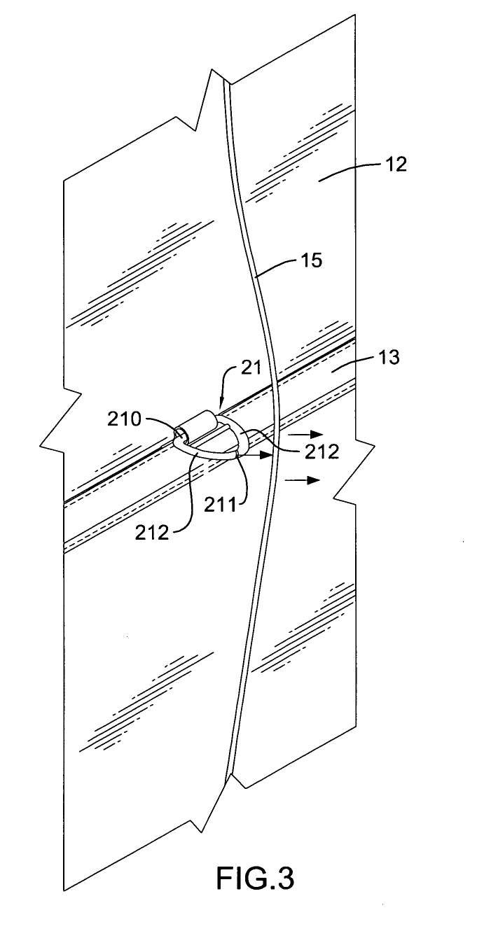

With reference to FIGS. 2 to 5, when children or pets are become entangles with the cord (15) and the cord (15) is pulled outward from the shade (12), the releasable ring (21) is deformed and the restraining arms (212) are opened. The cord (15) can be released from the gap (211) to provide the first safety measure, so the cord (15) is loosened and children or pets can free themselves from entanglement. If children or pets remain entangled and continue pulling on the cord (15), the connector insert (222) of the detachable connector (22) can be detached from the connector mount (221) to provide the second measure, then children and pets can free from the cord (15) and will be safe.

The safety blind assembly in accordance with the present invention provides two safety measures to prevent strangulation or entanglement so improves safety.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A safety blind assembly comprising:
a blind having
a rail having a bottom edge;
a shade attached to the bottom edge of the rail;
multiple medium slats mounted parallelly and separately on the shade;
a bottom slat mounted under the medium slats on the shade;
multiple cords, each cord having a connecting end and a free end, the connecting end mounted in the rail; and
a safety device having
multiple releasable rings mounted around the cords and on the medium slats, each releasable ring having a mounting section and a gap formed in the mounting section; and
multiple detachable connectors, each detachable connector having a connector mount and a connector insert, the connector mount mounted on the bottom slat, the connector insert inserted into the connector mount, detachable from the connector mount and attached to the free end of a corresponding cord.

2. The safety blind assembly as claimed in claim 1, wherein the mounting section of each releasable ring has two oblique restraining arms and is resilient, the two restraining arms are abutting one another at an apex of the releasable ring; and the gap of each releasable ring is formed at the apex of the restraining arms on the releasable ring.
